(19) United States
(12) Patent Application Publication
(10) Pub. No.: US 2019/0162949 A1
(43) Pub. Date: May 30, 2019

(54) MEMS DEVICE

(71) Applicant: DENSO CORPORATION, Kariya-city (JP)

(72) Inventors: Tetsuya ENOMOTO, Kariya-city (JP); Takashi KATSUMATA, Kariya-city (JP)

(21) Appl. No.: 16/261,904

(22) Filed: Jan. 30, 2019

Related U.S. Application Data
(63) Continuation of application No. PCT/JP2017/036352, filed on Oct. 5, 2017.

(30) Foreign Application Priority Data
Nov. 15, 2016 (JP) 2016-222541

(51) Int. Cl. G02B 26/08; G02B 26/10; H02N 2/02; H02N 2/06

(52) U.S. Cl. CPC G02B 26/0858; H02N 2/065; H02N 2/028; G02B 26/10

(57) ABSTRACT

A MEMS device includes a fixed portion fixed to a pedestal, a movable portion arranged inside the fixed portion and configured to be displaceable with respect to the fixed portion, a connecting portion that connects the fixed portion and the movable portion, a piezoelectric element disposed on at least one of the fixed portion or the connecting portion, and a detection portion that output a signal corresponding to a distortion of the movable portion. A voltage is applied to the piezoelectric element on the basis of the output signal of the detection portion thereby reducing the distortion transmitted from the fixed portion to the movable portion.

### CROSS REFERENCE TO RELATED APPLICATIONS

The present application is a continuation application of International Patent Application No. PCT/JP2017/036352 filed on Oct. 5, 2017, which designated the U.S. and claims the benefits of priority of Japanese Patent Application No. 2016-222541 filed on Nov. 15, 2016. The entire disclosure of all of the above applications is incorporated herein by reference.

### TECHNICAL FIELD

The present disclosure relates to a MEMS (Micro Electro Mechanical Systems) device.

### BACKGROUND

As a MEMS device, for example, an optical scanning device is known.

### SUMMARY

The present disclosure provides a MEMS device that includes a fixed portion fixed to a pedestal, a movable portion arranged inside the fixed portion and configured to be displaceable with respect to the fixed portion, a connecting portion that connects the fixed portion and the movable portion, a piezoelectric element disposed on at least one of the fixed portion or the connecting portion, and a detection portion that output a signal corresponding to a distortion of the movable portion. A voltage is applied to the piezoelectric element based on the output signal of the detection portion so as to reduce distortion transmitted from the fixed portion to the movable portion.

### BRIEF DESCRIPTION OF DRAWINGS

FIG. 1 is a plan view of a MEMS device according to a first embodiment;

FIG. 2 is a cross-sectional view taken along line II-II of FIG. 1,

FIG. 3 is a flowchart of distortion correction processing;

FIG. 4 is a cross-sectional view of a MEMS device according to a second embodiment, corresponding to FIG. 2 of the first embodiment;

FIG. 5 is a plan view of a MEMS device according to a third embodiment;

FIG. 6 is a plan view of a MEMS device according to a fourth embodiment;

FIG. 7 is a sectional view taken along line VII-VII in FIG. 6;

FIG. 8 is a plan view of a MEMS device according to a fifth embodiment;

FIG. 9 is a perspective view for explaining the operation of the to MEMS device according to the fifth embodiment; and

FIG. 10 is a plan view of a MEMS device according to a sixth embodiment.

### DETAILED DESCRIPTION

Hereinafter, embodiments of the present disclosure will be described with reference to the drawings. In the following embodiments, the same or equivalent parts are denoted by the same reference numerals as each other, and explanations will be provided to the same reference numerals.

### First Embodiment

A first embodiment will be described. A MEMS device of the present embodiment is an optical scanning device used for a head-up display, LIDAR (Light Detection and Ranging), and the like.

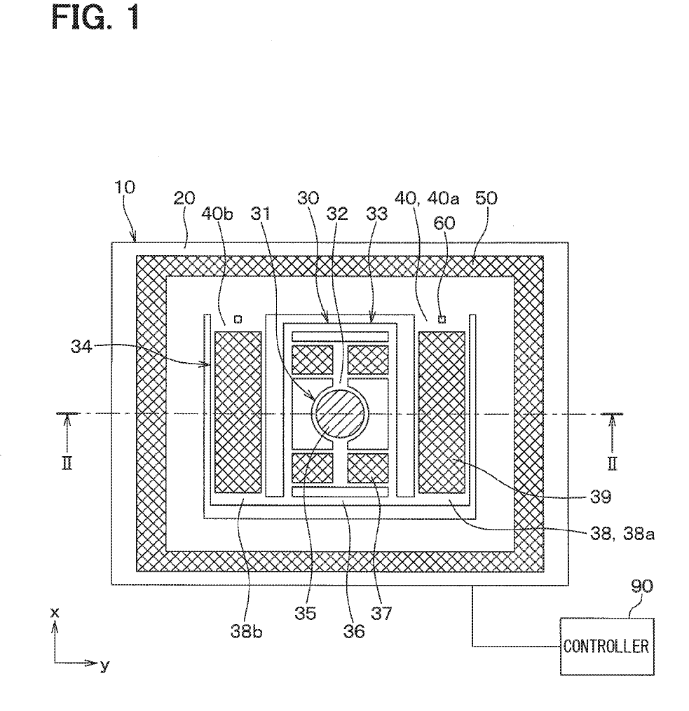

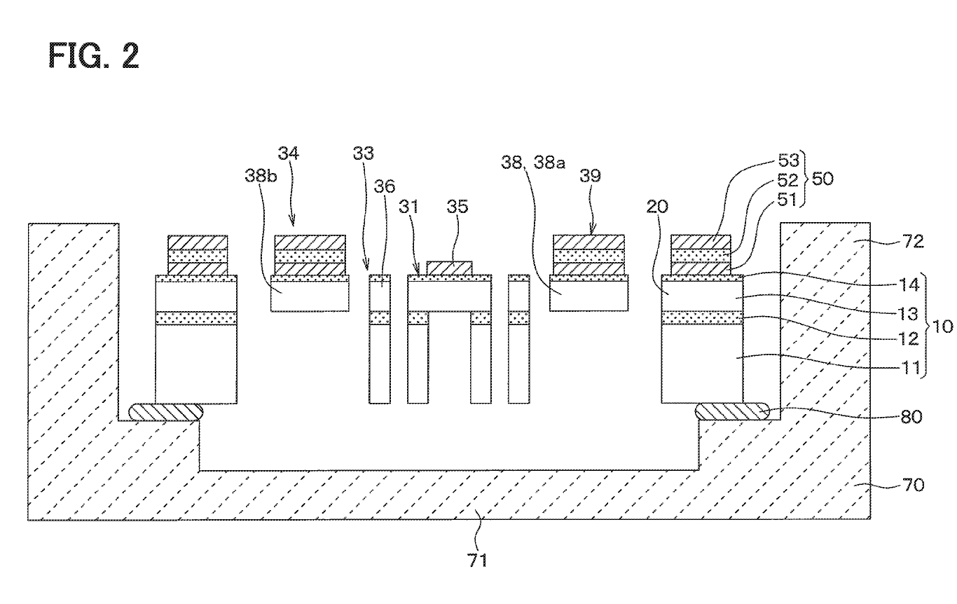

As shown in FIGS. 1 and 2, the MEMS device is formed by using a substrate 10, and includes a fixed portion 20, a movable portion 30, a connecting portion 40, a piezoelectric element 50, a detection portion 60, a pedestal 70, a die bonding material 80, and a controller 90. Although FIG. 1 is not a cross-sectional view, hatching is partially shown in order to make the figure easy understandable.

The substrate 10 includes an SOI (Silicon on Insulator) wafer in which an active layer 13 is provided on a support layer 11 made of a semiconductor such as silicon via a sacrifice layer 12, and an insulating layer 14 formed on a surface of the active layer 13. The fixed portion 20, the movable portion 30, and the connecting portion 40 are formed by processing such substrate 10.

The fixed portion 20 is a portion fixed to the pedestal 70 by the die bonding material 80, and the fixed portion 20 constitutes an outer peripheral frame of the MEMS device. Specifically, two directions parallel to the surface of the substrate 10 and perpendicular to each other are defined as X direction and Y direction. The fixed portion 20 has a rectangular frame shape including two sides parallel to the X direction and two sides parallel to the Y direction. The movable portion 30 is disposed inside the fixed portion 20.

The movable portion 30 is a portion used as an internal element of the MEMS device, and is movable with respect to the fixed portion 20. The movable portion 30 includes a mirror part 31, a beam part 32, a first drive part 33, and a second drive part 34.

The mirror part 31 reflects the light irradiated on the MEMS device, and as shown in FIG. 1, the mirror part 31 has a circular upper surface shape with respect to the substrate 10. The mirror part 31 has a light reflection layer 35 formed on the surface of the insulating layer 14, and the mirror part 31 reflects light on the surface of the light reflection layer 35. The light reflection layer 35 is made of, for example, aluminum or the like.

In addition, in the mirror part 31, a part of the substrate 10 is thinned. Specifically, in the region of the substrate 10 where the light reflection layer 35 is formed, the support layer 11 and the sacrifice layer 12 are removed. In an outer peripheral portion of the mirror part 31, the support layer 11 and the sacrifice layer 12 are left without being removed, so that a cylindrical rib is formed.

As shown in FIG. 1, the mirror part 31 is supported by the first drive part 33 via the beam part 32 extending on both sides in the X direction with the mirror part 31 as a center.

The first drive part 33 vibrates the beam part 32 and swings the mirror part 31 about an axis parallel to the X direction. The first drive part 33 includes a frame body 36 which is formed by patterning the substrate 10, and four piezoelectric elements 37 formed on an upper surface of the frame body 36.

The frame body 36 is a rectangular frame body including two sides parallel to the X direction and two sides parallel to the Y direction, and the mirror part 31 and the beam part 32 are arranged inside the frame body 36. The beam part 32 is connected to a central portion of each of two sides parallel to the Y direction of the frame body 36, and the piezoelectric elements 37 are disposed on both sides of the beam part 32 on these two sides.

In two sides parallel to the Y direction of the frame body 36, slits extending in the Y direction are formed in such a manner that the piezoelectric elements 37 are interposed between the slits and the mirror part 31. In addition, in the region where the piezoelectric elements 37 are formed, the support layer 11 and the sacrifice layer 12 are removed, and the substrate 10 is thinned.

The piezoelectric element 37 has a structure in which a lower electrode, a piezoelectric film, and an upper electrode are stacked in order, and the lower electrode and the upper electrode are connected to the controller 90 via wires (not shown).

The second drive part 34 swings the frame body 36 about an axis parallel to the Y direction and swings the mirror part 31 about an axis parallel to the Y direction. The second drive part 34 includes a base 38 which is formed by patterning the substrate 10 and two piezoelectric elements 39 formed on an upper surface of the base 38.

As shown in FIG. 1, the bases 38 are disposed on both sides of the mirror part 31 in the Y direction and extend on both sides in the X direction. In the bases 38, one side and the other side in the Y direction with respect to the mirror part 31 are defined as bases 38a and 38b, respectively. Ends of one side in the X direction of the bases 38a, 38b are extended in the Y direction, and are connected to the frame body 36. The other ends in the X direction of the bases 38a, 38b are connected to the fixed portion 20 via the connecting portion 40.

The piezoelectric elements 39 are arranged on the upper surface of the bases 38a, 38b. The piezoelectric element 39 has a structure in which a lower electrode, a piezoelectric film, and an upper electrode are stacked in order, and the lower electrode and the upper electrode are connected to the controller 90 via wires (not shown).

The connecting portion 40 connects the fixed portion 20 and the movable portion 30. In the connecting portion 40, portions connecting the bases 38a, 38b and the fixed portion 20 are referred to as so connecting portions 40a, 40b, respectively. In the present embodiment, the length in the Y direction of the connecting portions 40a, 40b is the same as the length of the bases 38a, 38b, and the connecting portions 40a, 40b extended in the X direction. The connecting portions 40a and 40b respectively connect an end portion of the bases 38a, 38b opposite to the side connected to the frame body 36 and the portion of the fixed portion 20 extending in the Y direction. In the base 38 and the connecting portion 40, the support layer 11 and the sacrifice layer 12 are removed, the substrate 10 is thinned, and the connecting portion 40 is thinner than the fixed portion 20.

The piezoelectric element 50 is provided for reducing the distortion transmitted from the fixed portion 20 to the movable portion 30 by deforming the fixed portion 20, and is arranged on at least one of the fixed portion 20 and the connecting portion 40. In the present embodiment, the piezoelectric element 50 is disposed only on the upper surface of the fixed portion 20, and is formed in a frame shape so as to surround the movable portion 30 and the connecting portion 40.

As shown in FIG. 2, the piezoelectric element 50 has a structure in which a lower electrode 51, a piezoelectric film 52, and an upper electrode 53 are stacked in order. The lower electrode 51 and the upper electrode 53 are made of, for example, Al, Au, Pt or the like. In addition, the piezoelectric film 52 is made of a piezoelectric material such as lead zirconate titanate (PZT), for example. The lower electrode 51 and the upper electrode 53 are connected to the controller 90 via wires (not shown).

The detection portion 60 is provided for measuring the distortion transmitted from the fixed portion 20 to the movable portion 30, and outputs a signal corresponding to the distortion of the movable portion 30. In the present embodiment, the detection portion 60 is formed of a strain gauge formed by injecting impurities into the substrate 10, and is formed on a surface layer portion of the connecting portion 40.

As shown in FIG. 2, the pedestal 70 includes a plate-like bottom portion 71 and a standing portion 72 provided in a direction perpendicular to a top surface of the bottom portion 71 from an outer peripheral portion of the bottom portion 71. The substrate 10 is fixed to the bottom portion 71 by the die bonding material 80 disposed between the substrate 10 and the bottom portion 71, and the piezoelectric elements 37, 39, and 50 are connected to a top end part of the standing portion 72 via a wiring and a bonding wire (not shown). The pedestal 70 is composed of a printed circuit board such as a glass epoxy board or a ceramic package. A circuit pattern (not shown) is formed on the pedestal 70, and the piezoelectric elements 37, 39, and 50 are connected to the controller 90 via the circuit pattern.

In the present embodiment, the die bonding material 80 is disposed between an outer peripheral portion of a back surface of the fixed portion 20 and the bottom portion 71. The piezoelectric element 50 is disposed in a region including a portion fixed to the pedestal 70 by the die bonding material 80 and an inside portion with respect to the portion in the fixed portion 20.

The controller 90 applies a voltage to the piezoelectric elements 37, 39 in order to swing the mirror part 31. In addition, the controller 90 also applies a voltage to the piezoelectric element 50, and changes the voltage to be applied to the piezoelectric element 50 based on the output signal of the detection portion 60. As a result, distortion transmitted from the fixed portion 20 to the movable portion 30 is reduced. The controller 90 is an electronic control device including a well-known microcomputer including a CPU, a ROM, a RAM and the like, and peripheral circuits thereof.

As described above, the MEMS device of the present embodiment is configured. In order to manufacture such a MEMS device, first, the surface of the active layer 13 of the SOI wafer is thermally oxidized to form the insulating layer 14, and the light reflection layer 35, each piezoelectric element, and the like are formed by sputtering or the like. Then, after processing the substrate 10 into a desired shape by etching, the substrate 10 is fixed to the pedestal 70 with the die bonding material 80, and wire bonding is performed.

In the MEMS device of the present embodiment, the controller 90 applies a drive voltage to the piezoelectric element 37 so that the first drive part 33 and the beam part 32 periodically deform and the mirror part 31 resonates and swings around an axis parallel to the X direction. In addition, the controller 90 applies the drive voltage to the piezoelectric element 39, so that the second drive part 34 periodically deforms, and the mirror part 31 and the first drive part 33 swing around the axis parallel to the Y direction. As a result, two-dimensional scanning is performed by a light reflected on the surface of the light reflection layer 35.

At this time, if distortion is generated in the fixed portion 20 due to thermal stress, mounting stress, characteristic change of the protective film (not shown), etc., this distortion is transmitted to the movable portion 30 and the resonance frequency of the movable portion 30 changes. In addition, when a distortion sensor (not shown) or the like for controlling the drive voltage applied to the piezoelectric elements 37, 39 is disposed, the distortion transmitted from the fixed portion 20 lowers the accuracy of this strain sensor.

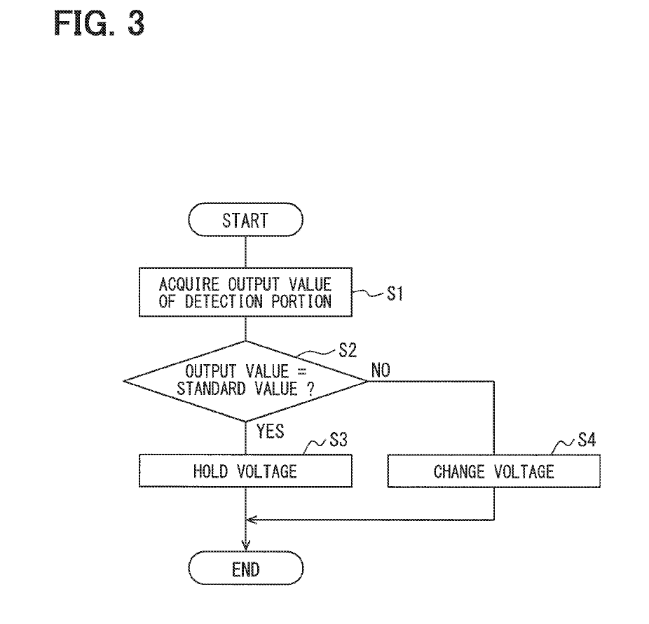

Therefore, the controller 90 of the present embodiment periodically and repeatedly executes the distortion correction processing shown in FIG. 3. As shown in FIG. 3, first, in step S1, the controller 90 acquires an output value of the detection portion 60, and proceeds to step S2. In step S2, the controller 90 determines whether or not the output value of the detection portion 60 is equal to a predetermined standard value.

This standard value is set based on the output value of the detection portion 60 measured when the distortion due to environmental change or the like does not occur in the fixed portion 20, or when the distortion of the fixed portion 20 is sufficiently small. Further, this standard value is set to a value having a range, and when distortion due to environmental change or the like does not occur in the fixed portion 20, or when the distortion transmitted from the fixed portion 20 to the movable portion 30 is sufficient, the output value of the detection portion 60 is set to be equal to the standard value.

Incidentally, the distortion of the movable portion 30 includes the distortion caused by a voltage application to the piezoelectric elements 37, 39, but in this case, the standard value is set in such a manner that the distortion transmitted from the fixed portion 20 among the distortion of the movable portion 30 is reduced.

When it is determined that the output value of the detection portion 60 is equal to the standard value, the controller 90 proceeds to step S3. In step 53, the controller 90 holds the voltage applied to the piezoelectric element 50 without changing it, and ends the distortion correction processing.

When it is determined that the output value of the detection portion 60 is not equal to the standard value, the controller 90 proceeds to step S4. In step S4, the controller 90 changes the voltage applied to the piezoelectric element 50, and ends the distortion correction processing. For example, if the output value of the detection portion 60 indicates that the movable portion 30 is compressed due to the distortion of the fixed portion 20, the controller 90 increases the voltage applied to the piezoelectric element 50, and compresses and deforms the fixed portion 20 together with the piezoelectric film 52. As a result, compressive deformation of the movable portion 30 is alleviated, and the output value of the detection portion 60 approaches the standard value.

In this way, by applying a voltage to the piezoelectric element 50 so that the output value of the detection portion 60 approaches the predetermined standard value, the driving force for correcting the distortion of the movable portion 30 is applied, and the distortion transmitted to the movable portion 30 from the fixed portion 20 is reduced. Therefore, it is possible to suppress the change in the characteristics of the movable portion 30 due to the distortion of the fixed portion 20. It is possible to reduce a temperature dependence of the MEMS device.

Further, if the MEMS device is an optical scanning device as in the present embodiment, it is possible to suppress changes in the resonance frequency of the movable portion 30 and the like. In addition, in the case where a strain sensor (not shown) or the like for controlling the drive voltage applied to the piezoelectric elements 37, 39 is disposed, it is possible to suppress deterioration of the accuracy of the strain sensor.

### Second Embodiment

A second embodiment will be described. The second embodiment is different from the first embodiment in the shape of the fixed portion 20 and the other parts are the same as those in the first embodiment, so only the parts different from the first embodiment will be described.

In the present embodiment, a portion of the portion of the fixed portion 20 where the piezoelectric element 50 is disposed is thinner than the portion of the fixed portion 20 fixed to the pedestal 70.

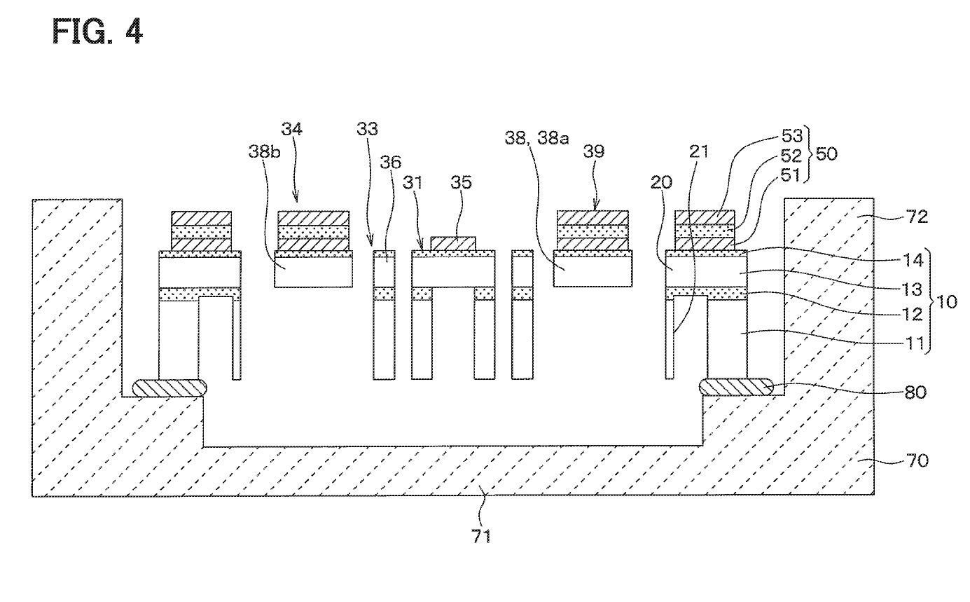

Specifically, as shown in FIG. 4, in a part of the portion of the fixed portion 20 where the piezoelectric element 50 is formed, a portion of the support layer 11 and the sacrifice layer 12 is removed and a concave portion 21 is formed. The concave portion 21 is formed in a portion closer to the movable portion 30 than the die bonding material 80 and the piezoelectric element 50 is formed in a region including the portion in which the concave portion 21 is formed and the portion outside the concave portion 21 in the fixed portion 20,

In the present embodiment in which the concave portion 21 is formed in the fixed portion 20, since the spring constant of the fixed portion 20 is smaller than that in the first embodiment, the deformation of the fixed portion 20 becomes large. The distortion transmitted to the movable portion 30 is easily absorbed at the portion where the piezoelectric element 50 is disposed. As a result, the distortion correction effect increases, and the distortion transmitted to the movable portion 30 can be further suppressed. In addition, since the width of the piezoelectric element 50 required for distortion correction is reduced, the MEMS device can be miniaturized.

### Third Embodiment

A third embodiment will be described. The third embodiment is different from the first embodiment in the configuration of the connecting portion 40 and the piezoelectric element 50, and the rest of the third embodiment is the same as the first embodiment, so only the parts different from the first embodiment will be described.

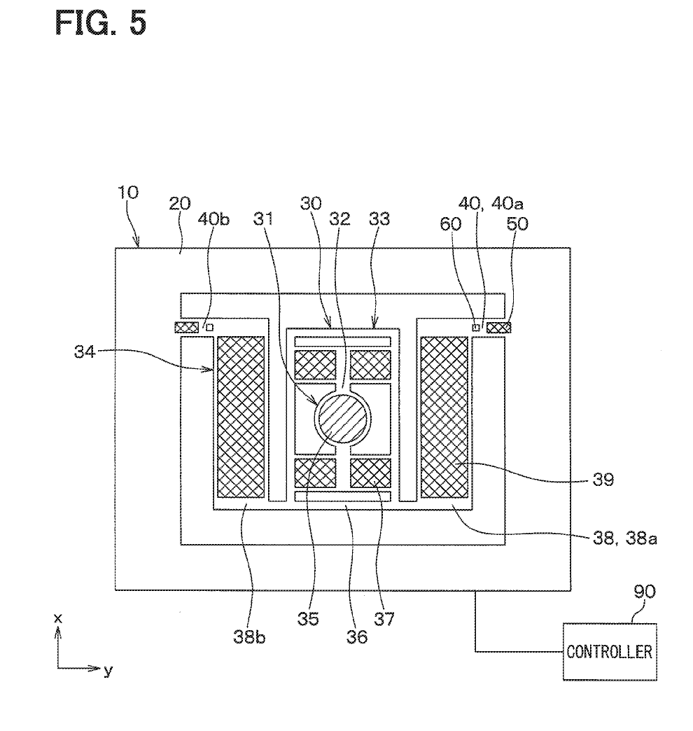

As shown in FIG. 5, in the present embodiment, the piezoelectric element 50 is disposed also in the connecting portion 40 in addition to the fixed portion 20. Specifically, the MEMS device has two piezoelectric elements 50, and each of the connecting portions 40a and 40b has a beam shape extending in the Y direction. One of the piezoelectric elements 50 is disposed from the fixed portion 20 to one end of the connecting portion 40a, and the other piezoelectric element 50 is disposed from the fixed portion 20 to one end of the connecting portion 40b.

In the connecting portion 40, the support layer 11 and the sacrifice layer 12 are removed. In other words, the connecting portion 40 is made thinner than the fixed portion 20, and the spring coefficient is lowered and the connecting portion 40 is easily deformed. Also in the present embodiment in which the piezoelectric element 50 is disposed on the connecting portion 40 having such an above mentioned shape, as in the second embodiment, it is possible to further suppress the distortion transmitted to the movable portion 30.

### Fourth Embodiment

A fourth embodiment will be described. In the fourth embodiment, the number of piezoelectric elements 50 is changed compared to the third embodiment, and the others are the same as in the third embodiment, so only the differences from the third embodiment will be described.

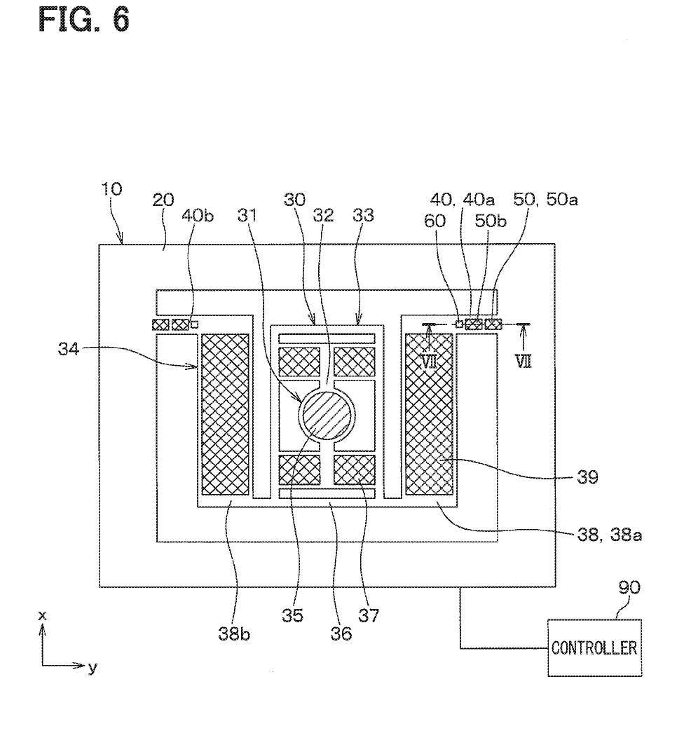

As shown in FIG. 6, in the present embodiment, four piezoelectric elements 50 are arranged in the MEMS device. Two of the four piezoelectric elements 50 are set as the piezoelectric element 50a, and the other two are set as the piezoelectric element 50b. As in the third embodiment, the piezoelectric element 50a is disposed from the fixed portion 20 to one end of the connection portion 40. The piezoelectric element 50b is disposed in the connection portion 40 in a state where it is separated from the movable portion 30 and the piezoelectric element 50a. The piezoelectric elements 50a and 50b correspond to the first piezoelectric element and the second piezoelectric element, respectively.

Further, in the present embodiment, the piezoelectric element 50 and the controller 90 are connected so that different voltages can be applied to the respective piezoelectric elements 50. Then, the controller 90 applies a voltage to the piezoelectric element 50a and the piezoelectric element 50b based on the output signal of the detection portion 60. As a result, distortion transmitted from the fixed portion 20 to the movable portion 30 is reduced.

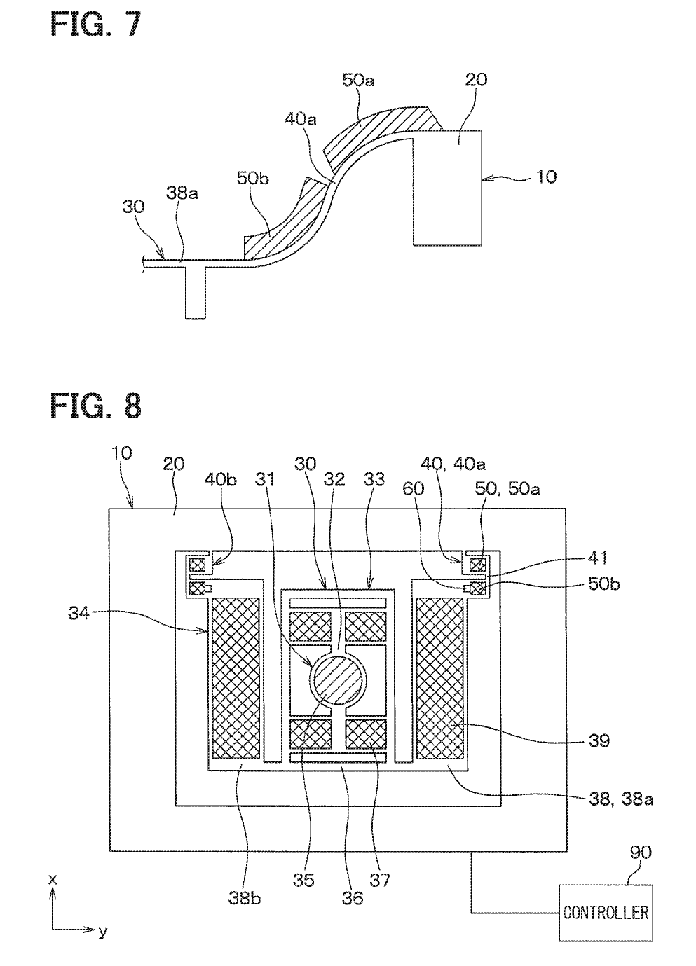

For example, when a voltage is applied only to the piezoelectric element 50b among the piezoelectric elements 50a and 50b, as shown in FIG. 7, the piezoelectric element 50b is compressed and deformed. The piezoelectric element 50a is pulled so as to protrude toward the upper surface side, and the movable portion 30 is displaced downward with respect to the fixed portion 20. In addition, when a voltage is applied only to the piezoelectric element 50a, the piezoelectric element 50a is compressed and deformed, the piezoelectric element 50b is pulled so as to be convex toward the upper surface side, and the movable portion 30 is displaced upward with respect to the fixed portion 20. When a voltage is applied to both of the piezoelectric elements 50a and 50b, the piezoelectric elements 50a and 50b are compressed and deformed, and the movable portion 30 is pulled outward.

As described above, in the present embodiment, the movable portion 30 can be displaced in the vertical direction with respect to the fixed portion 20. As a result, the distortion transmitted from the fixed portion 20 to the movable portion 30 can be further suppressed.

### Fifth Embodiment

A fifth embodiment will be described. The fifth embodiment is different from the fourth embodiment in the configuration of the connecting portion 40 and the arrangement of the piezoelectric element 50, and the other aspects are the same as those in the fourth embodiment, so only the parts different from the fourth embodiment will be explained.

As shown in FIG. 8, in the present embodiment, each of the connecting portions 40a, 40b includes a beam portion 41. An upper surface of the beam portion 41 is formed in an U shape which includes a central part extending in the X direction and both end parts extending in the Y direction. One end part of the beam portion 41 is connected to the base 38 and the other end portion further extends in the X direction and is connected to the fixed portion 20. As a result, the upper surfaces of the connecting portions 40a, 40b are meander-shaped.

The piezoelectric element 50a is disposed on the side of the end portion connected to the fixed portion 20 in the beam portion 41. The piezoelectric element 50b is disposed on the other side of the beam portion 41 in a state where it is separated from the movable portion 30 and the piezoelectric element 50a.

In the connecting portion 40, the connecting portion with the fixed portion 20, the connecting portion with the movable portion 30, and the central portion of the beam portion 41 have the same thickness as the fixed portion 20. In the portion of the beam portion 41 where the piezoelectric element 50 is disposed, the support layer 11 and the sacrifice layer 12 are removed, and the substrate 10 is thinned.

The longitudinal direction of the piezoelectric elements 50a and 50b is coincident with the longitudinal direction of the fixed portion 20. Further, the connecting portion 40 is connected to a portion of the fixed portion 20 parallel to the longitudinal direction of the fixed portion 20.

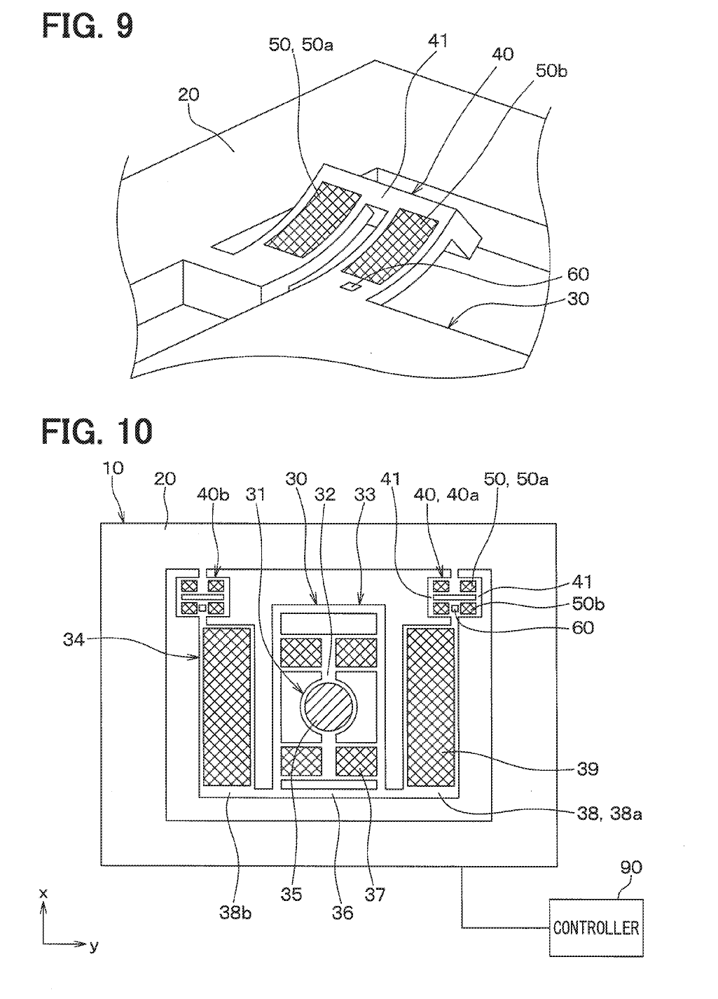

The portion of the substrate 10 where the piezoelectric element 50 is disposed is deformed so as to be convex toward the support layer 11 due to a film stress at the time of film formation of the piezoelectric element 50. On the other hand, in the present embodiment in which the piezoelectric elements 50a, 50b are arranged as described above, as shown in FIG. 9, the displacement in the thickness direction of the connecting portion 40 due to the deformation of the piezoelectric element 50a is canceled by the deformation of the piezoelectric element 50b. A difference in the position in the thickness direction of the substrate 10 between the end portion on the fixed portion 20 side of the connecting portion 40 and the end portion on the movable portion 30 side is suppressed. Therefore, the position in the thickness direction of the movable portion 30 with respect to the fixed portion 20 can be prevented from changing due to the influence of the stress of the piezoelectric element 50.

Since the fixed portion 20 is formed in the rectangular frame shape, the deformation due to thermal stress or the like increases in the longitudinal direction. Therefore, in order to prevent the distortion in the longitudinal direction of the fixed portion 20 from being largely transmitted to the movable portion 30, it is preferable to connect the connecting portion 40 to a portion of the fixed portion 20 extending in the longitudinal direction as in the present embodiment.

Further, the piezoelectric element is more deformed in the longitudinal direction than in the transverse direction. Therefore, it is preferable to make the longitudinal direction of the piezoelectric elements 50a, 50b coincide with the longitudinal direction of the fixed portion 20 as in the present embodiment in order to absorb the distortion transmitted from the fixed portion 20 more.

### Sixth Embodiment

A sixth embodiment will be described hereafter. The sixth embodiment is different from the fifth embodiment in the configuration of the connecting portion 40 and the number of the piezoelectric elements 50, and the other aspects are the same as those in the fifth embodiment, so only the parts different from the fifth embodiment will be explained.

As shown in FIG. 10, in the present embodiment, each of the connecting portions 40a, 40b includes two beam portions 41. The two beam portions 41 of the connecting portion 40a are arranged to face each other and are connected at both end portions. Further, in the present embodiment, the end portion of the beam portion 41 on the side of the movable portion 30 is extended in the Y direction and further extends in the X direction and is connected to the base 38. Piezoelectric elements 50a and 50b are respectively disposed on the two beam portions 41 as in the fifth embodiment. That is, four piezoelectric elements 5 are arranged in the connecting portion 40a. Likewise, four piezoelectric elements 50 are disposed also in the connecting portion 40b.

Even in the present embodiment in which the connecting portion 40 has such a configuration, as in the fifth embodiment, the displacement of the movable portion 30 in the thickness direction due to the influence of the stress in the piezoelectric element 50 can be suppressed.

### Other Embodiments

The present disclosure is not limited to the above-described embodiments, and can be appropriately modified. The embodiments described above are not independent of each other, and can be appropriately combined except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

For example, in the first and second embodiments, the piezoelectric element 50 may be disposed only on a portion of the fixed portion 20 extending in the longitudinal direction. Even in the above mentioned configuration, since the deformation due to thermal stress or the like in the fixed portion 20 increases in the longitudinal direction, the distortion transmitted from the fixed portion 20 to the movable portion 30 can be reduced to some extent.

Further, the detection portion 60 may be constituted by sensors other than the strain gauge. For example, the detection portion 60 may be configured with a piezoelectric sensor that measures the amount of distortion by detecting the charge movement of the piezoelectric film. With such a configuration, since the detection portion 60 can be formed in the same process as the piezoelectric element 50, the manufacturing cost of the MEMS device can be reduced.

Further, the present disclosure may be applied to MEMS devices other than the optical scanning device. For example, by applying the present disclosure to a piezoelectric gyro sensor, an acceleration sensor or the like, the accuracy of these sensors can be improved.

The present disclosure aims to provide a MEMS device that is capable of suppressing a change in characteristics of an internal element due to distortion of an outer peripheral frame.

According to one aspect of the present disclosure, a MEMS device includes a fixed portion fixed to a pedestal, a movable portion arranged inside the fixed portion and made displaceable with respect to the fixed portion, a connecting portion that connects the fixed portion and the movable portion, a piezoelectric element disposed on at least one of the fixed portion and the connecting portion, and a detection portion that output a signal corresponding to a distortion of the movable portion. A voltage is applied to the piezoelectric element on the basis of the output signal of the detection portion thereby reducing the distortion transmitted from the fixed portion to the movable portion.

With such a configuration, the fixed portion is deformed by applying a voltage to the piezoelectric element. Accordingly, in the case where the fixed portion is the outer peripheral frame and the movable portion is the inner element, by adjusting the voltage applied to the piezoelectric element based on the output signal of the detection portion, distortion transmitted from the outer peripheral frame to the inner element can be reduced. It is possible to suppress changes in the characteristics of the inner element.

1. A MEMS device comprising:
a fixed portion fixed to a pedestal;
a movable portion disposed inside the fixed portion and being configured to be displaceable with respect to the fixed portion;
a connecting portion that connects the fixed portion and the movable portion;
a piezoelectric element arranged on at least one of the fixed portion or the connecting portion; and
a detection portion configured to output a signal corresponding to a distortion of the movable portion, wherein
a voltage is applied to the piezoelectric element based on the output signal of the detection portion so as to reduce distortion transmitted from the fixed portion to the movable portion.

2. The MEMS device according to claim 1, wherein
the piezoelectric element is disposed on the fixed portion and the connecting portion.

3. The MEMS device according to claim 2, wherein
the connection portion has a beam shape, and
the piezoelectric element is disposed from the fixed portion to one end portion of the connecting portion.

4. The MEMS device according to claim 3, wherein
the piezoelectric element includes a first piezoelectric element and a second piezoelectric element,
the first piezoelectric element is disposed from the fixed portion to one end portion of the connecting portion, and
the second piezoelectric element is disposed on the connection portion in a state where the second piezoelectric element is separated from the movable portion and the first piezoelectric element.

5. The MEMS device according to claim 2, wherein
the connection portion includes a U-shaped beam portion, and
the piezoelectric element is disposed on one end side of the beam portion.

6. The MEMS device according to claim 5, wherein
the piezoelectric element includes a first piezoelectric element and a second piezoelectric element,
the first piezoelectric element is disposed on one end side of the beam portion, and
the second piezoelectric element is disposed on the other end side of the beam portion in a state where the second piezoelectric element is separated from the movable portion and the first piezoelectric element.

7. The MEMS device according to claim 4, wherein
the voltage is applied to the first piezoelectric element and the second piezoelectric element based on the output signal of the detection portion so as to reduce the distortion transmitted from the fixed portion to the movable portion.

8. The MEMS device according to claim 1, wherein
a longitudinal direction of the piezoelectric element coincides with a longitudinal direction of the fixed portion.

9. The MEMS device according to claim 1, wherein
the connecting portion is connected to a portion of the fixed portion parallel to a longitudinal direction of the fixed portion.

10. The MEMS device according to claim 1, wherein
the detection portion is constituted by a piezoelectric sensor that measures a distortion amount by detecting a charge movement of a piezoelectric film.

11. The MEMS device according to claim 1, wherein
at least a part of a portion of the fixed portion and the connecting portion where the piezoelectric element is disposed is made thinner than a portion of the fixed portion fixed to the pedestal.

12. The MEMS device according to claim 1, wherein
the movable portion includes a mirror part that reflects light and a drive part that swings the mirror part.
